(19) United States
(12) Patent Application Publication
(10) Pub. No.: US 2014/0212802 A1
(43) Pub. Date: Jul. 31, 2014

(54) MULTI-LAYERED ELECTROPHOTOGRAPHIC PHOTOSENSITE MEMBER, IMAGE FORMING APPARATUS, AND METHOD FOR PRODUCING MULTI-LAYERED ELECTROPHOTOGRAPHIC PHOTOSENSITIVE MEMBER

(71) Applicant: KYOCERA DOCUMENT SOLUTIONS INC., Osaka (JP)

(72) Inventors: Junichiro OTSUBO, Osaka (JP); Jun AZUMA, Osaka (JP); Takayuki INOUE, Osaka (JP)

(73) Assignee: KYOCERA DOCUMENT SOLUTIONS INC., Osaka (JP)

(21) Appl. No.: 14/168,959

(22) Filed: Jan. 30, 2014

(30) Foreign Application Priority Data
Jan. 30, 2013 (JP) 2013-016002

(51) Int. Cl. G03G 15/00; B05D 5/12

(52) U.S. Cl. CPC G03G 5/0564
USPC 430/56; 399/159; 430/59.6; 430/59.5; 427/58

(57) ABSTRACT

A multi-layered electrophotographic photosensitive member includes a multi-layered photosensitive layer. In the multi-layered photosensitive layer, a charge generating layer that contains a charge generating material and a charge transport layer that contains a charge transport material and a binder resin are layered sequentially. The binder resin includes a polycarbonate resin represented by a formula (1).

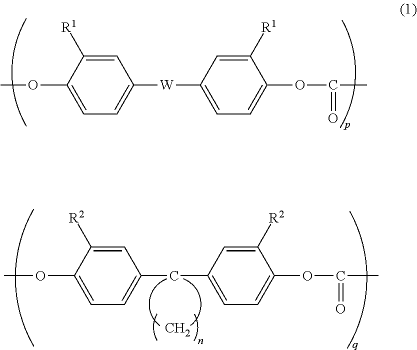

### INCORPORATION BY REFERENCE

The present application claims priority under 35 U.S.C. §119 to Japanese Patent Application No. 2013-016002, filed Jan. 30, 2013. The contents of this application are incorporated herein by reference in their entirety.

### BACKGROUND

The present disclosure relates to a multi-layered electrophotographic photosensitive member, an image forming apparatus, and a method for producing a multi-layered electrophotographic photosensitive member.

An electrographic image forming apparatus includes an electrophotographic photosensitive member. Examples of electrophotographic photosensitive members include inorganic photosensitive members and organic photosensitive members. Inorganic photosensitive members include a photosensitive layer contains an inorganic material such as selenium or amorphous silicon. Organic photosensitive members include a photosensitive layer mainly contains an organic material such as binder resin, charge generating material, and charge transport material. Organic photosensitive members have been widely used as electrophotographic photosensitive members. That is because organic photosensitive members can be produced more easily than inorganic photosensitive members, and various materials can be selected to give more flexibility in design for the photosensitive layer.

Examples of such an organic photosensitive member include a single layer organic photosensitive member, and multi-layered organic photosensitive member. The single layer organic photosensitive member includes a photosensitive layer that contains both a charge generating material and a charge transport material in one layer. The multi-layered organic photosensitive member includes a photosensitive layer that includes a charge generating layer containing a charge generating material; and a charge transport layer containing a charge transport material. Since the each layer of the multi-layered organic photosensitive members has either function to generate or transport charges, in general, multi-layered organic photosensitive members often show an improved electric performance compared to single layer organic photosensitive members. Therefore, multi-layered organic photosensitive members have been widely used as a photosensitive member for printers or multifunction peripherals.

While organic photosensitive members have these advantages described above, an organic material used is soft, and thus the material has a disadvantage that the photosensitive layer is easy to wear by using the photosensitive member repeatedly. Therefore, a lot of researches have been made for improving the abrasive resistance of the charge transport layer in the multi-layered organic photosensitive member. The improvement of the binder resin, which is a main component of the charge transport layer, is important consideration in these researches, and various suggestions are reported.

### SUMMARY

The first aspect of the disclosure relates to a multi-layered electrophotographic photosensitive member. The multi-layered electrophotographic photosensitive member includes a multi-layered photosensitive layer. In the multi-layered photosensitive layer, a charge generating layer that contains a charge generating material and a charge transport layer that contains a charge transport material and a binder resin are layered sequentially.

The binder resin includes a polycarbonate resin represented by a formula (1):

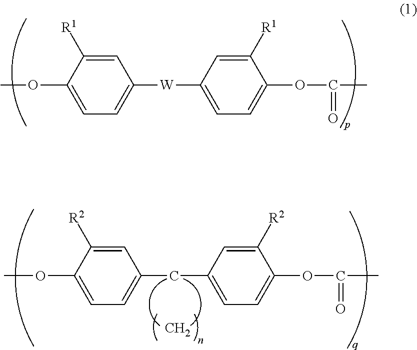

In the formula (1), p+q=1; 0.3≦p≦0.8; W is a single bond, or —O—; R¹ and R² are each independently a hydrogen atom, an alkyl group, or an aryl group; n is 3 or 4.

The second aspect of the disclosure relates to an image forming apparatus. The image forming apparatus includes:

an image bearing member;

a charger for charging the surface of the image bearing member;

an exposure section for exposing the charged surface of the image bearing member and forming an electrostatic latent image on the surface of the image bearing member;

a developing section for developing the electrostatic latent image and forming a toner image; and

a transfer section for transferring the toner image from the image bearing member to a transfer target. The image bearing member is the electrophotographic photosensitive member according to the first aspect of the disclosure.

### BRIEF DESCRIPTION OF THE DRAWINGS

FIG. 1A and FIG. 1B are each figures showing a configuration of a multi-layered photosensitive member.

FIG. 2 is a schematic diagram showing one example of image forming apparatus according to the disclosure.

### DETAILED DESCRIPTION

Now, embodiments of the disclosure will be described in detail. The disclosure is not limited by the embodiments, and can be modified and performed as needed within the scope of purpose of the disclosure. We may omit the description described previously if needed; however, the summary of the disclosure is not limited.

### First Embodiment

The first embodiment of the disclosure is a multi-layered photosensitive member. The multi-layered photosensitive member includes a multi-layered photosensitive layer that includes a charge generating layer containing a charge generating material; and a charge transport layer containing a charge transport material and a binder resin, and the charge generating layer and the charge transport layer are layered sequentially on a conductive substrate. The charge transport layer contains a polycarbonate resin represented by a formula (1) as a binder resin:

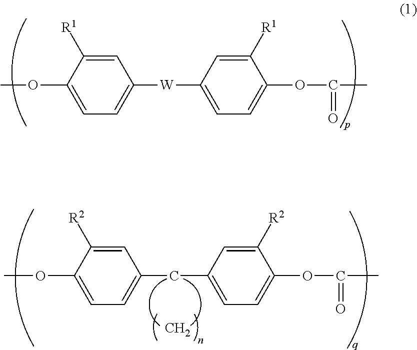

In the formula (1), p+q=1; 0.3≦p≦0.8; W is a single bond, or —O—; R¹ and R² are each independently a hydrogen atom, an alkyl group, or an aryl group; n is 3 or 4.

Within the scope of the specification and claims of the application, a resin contained in the charge transport layer 13 of the multi-layered photosensitive member is referred as “binder resin”. Also, if a resin is contained in the charge generating layer 12 of the multi-layered photosensitive member, a resin contained in the charge generating layer 12 is referred as “base resin”. Hereinafter, the multi-layered electrophotographic photosensitive member according to the first embodiment of the disclosure will be described.

### <Multi-Layered Electrophotographic Photosensitive Member>

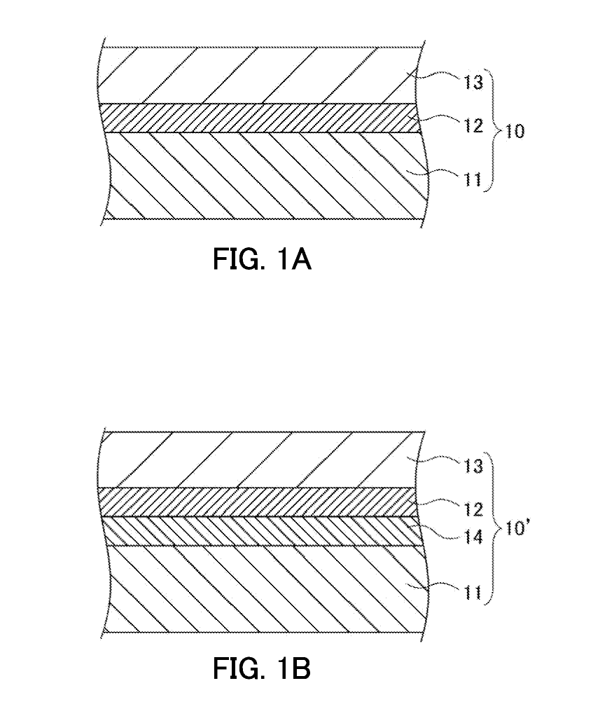

FIG. 1A shows an example of configuration of a multi-layered electrophotographic photosensitive member. The multi-layered electrophotographic photosensitive member (hereinafter also called as “multi-layered photosensitive member” or “photosensitive member”) 10 includes a multi-layered photosensitive layer (hereinafter referred as “photosensitive layer”) in which the charge generating layer 12 and the charge transport layer 13 are layered sequentially. The multi-layered electrophotographic photosensitive member 10 is made as follows. That is, the charge generating layer 12 containing a charge generating material is formed on the conductive substrate 11 by means such as deposition or application. An application liquid containing a charge transport material and a binder resin is applied on the charge generating layer 12, and then dried the layer to form the charge transport layer 13.

The multi-layered electrophotographic photosensitive member can be applied to any charging method including positively charging or negatively charging by selecting the type of the charge transport material, if needed.

FIG. 1B shows another aspect of a configuration of a multi-layered photosensitive member 10′. As shown in FIG. 1B, an undercoat layer 14 is preferably preformed on the conductive substrate 11 before forming a multi-layered photosensitive layer. Providing the undercoat layer 14 can prevent the injection of charges from the side of the conductive substrate 11 into the photosensitive layer. In addition, providing the undercoat layer 14 can increase the binding strength of the photosensitive layer to the conductive substrate 11, and cover defects on the surface of the conductive substrate 11 to smooth the surface.

Hereinafter, with respect to the multi-layered electrophotographic photosensitive member 10 (10′), the conductive substrate 11, the multi-layered photosensitive layer, and the method for producing the multi-layered photosensitive layer will be described.

### [Conductive Substrate]

The conductive substrate 11 is not particularly limited as long as the substrate can be used as a conductive substrate of the electrophotographic photosensitive member 10 (10′). Illustrative example of the conductive substrate includes the one that at least surface part is constructed by conductive material. In illustrative example, the conductive substrate 11 may contain a conductive material. The conductive substrate 11 may be the one that surface of material, e.g., plastic material, is covered with conductive material. Also, examples of conductive materials include aluminum, iron, copper, tin, platinum, silver, vanadium, molybdenum, chromium, cadmium, titanium, nickel, palladium, indium, stainless steel, and brass. Further, as a conductive material, single (one) conductive material may be used. Two or more conductive materials may be combined to use the materials as an alloy, for example. Among them, the conductive substrate preferably contains aluminum or aluminum alloy. Use of the conductive substrate containing aluminum or aluminum alloy can provide a photosensitive member which is capable of forming more suitable images. That is likely because charges seem to move from the multi-layered photosensitive layer to the conductive substrate 11 satisfactory.

The shape of the conductive substrate 11 can be appropriately selected according to the configuration of the image forming apparatus used. As the conductive substrate 11, any substrate in sheet like shape, drum like shape, or the like can be employed. The thickness of the conductive substrate 11 can be selected depending on the shape of the substrate, if needed.

### [Photosensitive Layer]

The multi-layered electrophotographic photosensitive member 10 (10′) includes multi-layered photosensitive layer in which the charge generating layer 12 containing at least the charge generating material and the charge transport layer 13 containing at least the charge transport material and binder resin are layered sequentially on the conductive substrate 11. The charge generating layer 12 may include a base resin. Hereinafter, a binder resin, a charge transport material, a charge generating material, and a base resin will be described sequentially.

### (Binder Resin)

The charge transport layer 13 in the multi-layered electrophotographic photosensitive member 10 (10′) contains a polycarbonate resin represented by the formula (1) as a binder resin:

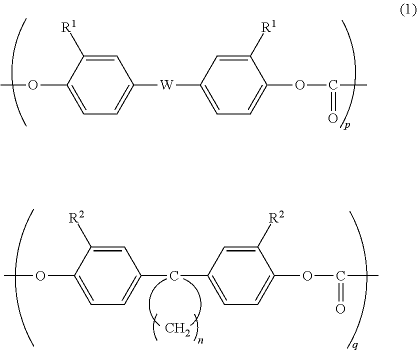

In the formula (1), p+q=1; 0.3≦p≦0.8; W is a single bond, or —O—; R¹ and R² are each independently a hydrogen atom, an alkyl group, or an aryl group; n is 3 or 4.

In the formula (1), 0.3≦p≦0.8, preferably 0.3≦p≦0.7. Use the binder resin including the polycarbonate resin with a range of p being 0.3≦p≦0.8 results in the photosensitive member having improved electric properties and abrasive resistance.

If p is too high, solubility of polycarbonate resin represented by the formula (1) to solvent tends to decrease. Therefore, if p is too high in the polycarbonate resin represented by the formula (1), when used an application liquid obtained by dissolving the binder resin (binder resin containing polycarbonate resin represented by the formula (1)) to a solvent during formation of the photosensitive layer, the binder resin is easy to crystallize even if a small amount of solvent is volatilized, and the photosensitive layer may become clouded. In this case, electric properties of the photosensitive member tend to be lost. If the problem is occurred, crystallization of the resin can be avoided by increasing the amount of solvent. By decreasing the viscosity of the application liquid, however, time required to produce the photosensitive layer becomes longer, and productivity of the photosensitive member is decreased.

If the substituent groups R¹ and R² in the polycarbonate resin of the formula (1) are alkyl group, substituent groups R¹ and R² are preferably an alkyl group having 1 to 12 carbon atoms, more preferably an alkyl group having 1 to 8 carbon atoms, and particularly preferably an alkyl group having 1 to 6 carbon atoms.

If the substituent groups represented by R¹ and R² are alkyl group, illustrative examples of alkyl groups include a methyl group, an ethyl group, an n-propyl group, an iso-propyl group, an n-butyl group, a sec-butyl group, a ter-butyl group, an n-pentyl group, an iso-pentyl group, a tert-pentyl group, a neopentyl group, an n-hexyl group, an iso-hexyl group, an n-heptyl group, an n-octyl group, a 2-ethylhexyl group, a tert-octyl group, an n-nonyl group, an n-decyl group, an n-undecyl group, or a dodecyl group.

In the formula (1), if the substituent groups R¹ and R² are aryl group, preferred aryl group is phenyl group. Or, preferred aryl group is a group formed by condensation of 2 to 6 benzene rings each other, or a group formed by connecting the rings with single bond. The amount of benzene rings in the aryl group is preferably 1 to 6, more preferably 1 to 3, particularly preferably 1 or 2.

If the substituent groups represented by R¹ and R² are alkyl group, illustrative examples include phenyl group, naphthyl group, biphenylyl group, anthryl group, phenanthryl group, or pyrenyl group.

In the formula (1), n is 3 or 4. That is, the polycarbonate resin represented by the formula (1) has a cyclobutylidene group or cyclopentylidene group. The cyclobutylidene group or cyclopentylidene group is not bulky compared to cyclohexylidene group, and the like. Therefore, the polycarbonate resin represented by the formula (1) is easy to fill densely in the binder resin. Thus, use of the binder resin including the polycarbonate resin represented by the formula (1) can easily form the multi-layered photosensitive member 10 (10′) including the charge transport layer 13 with improved strength and abrasive resistance. In contrast, if n is larger than 4, a cycloalkylidene group contained in the polycarbonate resin has more steric hindrance than if n is 3 or 4. Therefore, molecular chains of the polycarbonate resin do not fill densely in the binder resin. Thus, even if the polycarbonate resin represented by the formula (1) is used, when the polycarbonate resin wherein n is larger than 4 is used, the multi-layered photosensitive member 10 (10′) including the charge transport layer 13 with improved strength and abrasive resistance is hard to be formed.

The method for producing a polycarbonate resin represented by the formula (1) is not particularly limited. For example, the polycarbonate resin represented by the formula (1) can be produced by using a bisphenol compound corresponding to the repeating unit as described in the formula (1) according to any known method for producing polycarbonate resins.

Among the polycarbonate resin represented by the formula (1), illustrative examples of suitable polycarbonate resin include Resin-A to Resin-D represented by the following formulae. In the formulae representing Resin-A to Resin-D, p and q has the same meaning as in the formula (1).

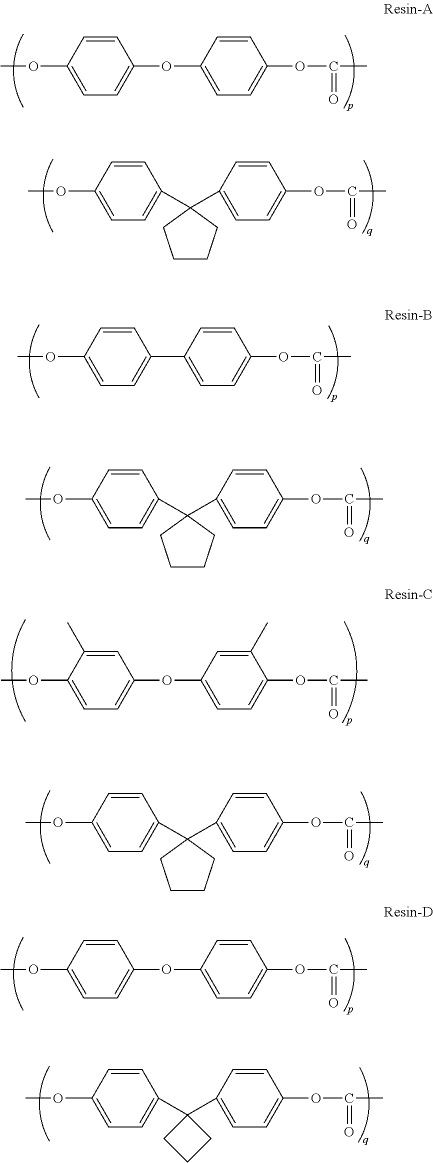

The polycarbonate resin represented by the formula (1) may be any random copolymer or block copolymer, unless it limits the purpose of the disclosure. The polycarbonate resin represented by the formula (1) preferably has a viscosity average molecular weight of 35,000 to 90,000, more preferably 40,000 to 80,000. Also, preferred viscosity average molecular weight of the binder resin is the same as the polycarbonate resin represented by the formula (1). When the binder resin has a viscosity average molecular weight of 35,000 to 90,000, the binder resin has a moderate hardness. Therefore, the charge transport material is well dispersed in the binder resin to obtain the photosensitive member having improved electric properties and abrasive resistance.

For measuring the viscosity average molecular weight [M] of the polycarbonate resin, the intrinsic viscosity [η] are calculated by using Ostwald viscometer. Then, it is calculated by Schnell formula: [η]=1.23Bad10⁴ M^{0.83}, where, [η] can be measured by using a solution of the polycarbonate resin. The solution of the polycarbonate resin is obtained by resolving the polycarbonate resin in methylene chloride as a solvent at 20° C. so that the concentration becomes 6.0 g/dm³.

The content of the polycarbonate resin represented by formula (1) based on total amount of the binder resin in the charge transport layer 13 is not particularly limited, unless it limits the purpose of the disclosure. The content of the polycarbonate resin represented by formula (1) is, however, preferably 70% by mass or more, more preferably 90% by mass or more, particularly preferably 100% by mass.

### (Charge Transport Material)

The charge transport material is not particularly limited, as long as the material can be used as a charge transport material contained in the photosensitive layer of the electrophotographic photosensitive member. Examples of the charge transport material include, for example, hole transport materials for transporting a hole which is positive charge and electron transport materials for transporting an electron which is negative charge.

Hole Transport Material

The hole transport material (HTM) is not particularly limited, as long as the material can be used as a hole transport material contained in the photosensitive layer of the electrophotographic photosensitive member. Illustrative examples of the hole transport materials include benzidine derivative, oxadiazole based compound (e.g., 2,5-di(4-methylaminophenyl)-1,3,4-oxadiazole), styryl based compound (e.g., 9-(4-diethylaminostyryl)anthracene), carbazole based compound (e.g., polyvinyl carbazole), organic polysilane compound, pyrazoline based compound (e.g., 1-phenyl-3-(p-dimethylaminophenyl)pyrazoline), nitrogen containing cyclic compound or condensed polycyclic compound (e.g., hydrazone based compound, triphenyl amine based compound, indole based compound, oxazole based compound, isoxazole based compound, thiazole based compound, or triazole based compound). Among these hole transport materials, triphenyl amine based compounds having one or multiple triphenyl amine backbone in one molecule are more preferred. These hole transport materials may be used alone, or a combination of two or more hole transport materials may be used.

Electron Transport Material

The electron transport material (ETM) is not particularly limited, as long as the material can be used as an electron transport material contained in the photosensitive layer of the electrophotographic photosensitive member. Illustrative examples include quinone derivative (e.g., naphthoquinone derivative, diphenoquinone derivative, anthraquinone derivative, azoquinone derivative, nitroanthraquinone derivative, or dinitroanthraquinone derivative), malononitrile derivative, thiopyran derivative, trinitro-thioxanthone derivative, 3,4,5,7-tetranitro-9-fluorenone derivative, dinitroanthracene derivative, dinitroacridine derivative, tetracyanoethylene, 2,4,8-trinitro-thioxanthone, dinitrobenzene, dinitroanthracene, dinitroacridine, succinic anhydride, maleic anhydride, or dibromomaleic anhydride. The electron transport material may be used alone, or a combination of two or more electron transport materials may be used.

### (Charge Generating Material)

The charge generating material is not particularly limited, unless it limits the purpose of the disclosure. As a charge generating material, any charge generating materials can be used by selecting from any charge generating materials used in the photosensitive layer of the electrophotographic photosensitive member as desired. Examples of the charge generating materials include X-form metal-free phthalocyanine (x-H₂Pc) represented by the following formula (I), α-type or Y-form titanyl phthalocyanine (Y—TiOPc) represented by the following formula (II), perylene pigment, bisazo pigment, dithioketo pyrrolo pyrrole pigment, metal-free naphthalocyanine pigment, metal naphthalocyanine pigment, squaraine pigment, trisazo pigment, indigo pigment, azulenium pigment, cyanine pigment, powder of inorganic photoconducting material (e.g., selenium, selenium-tellurium, selenium-arsenic, cadmium sulfide, or amorphous silicon), pyrylium salt, anthanthrone based pigment, triphenyl methane based pigment, threne based pigment, toluidine based pigment, pyrazoline based pigment, or quinacridone based pigment. Among these charge generating materials, X-form metal-free phthalocyanine, or α-type or Y-form titanyl phthalocyanine is preferred.

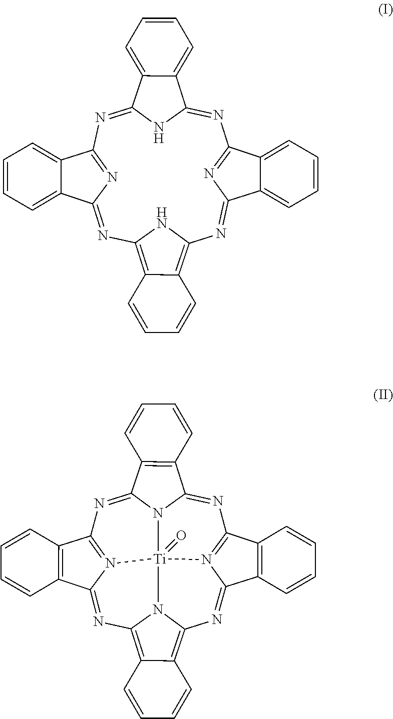

In order to improve the sensitivity, the following titanyl phthalocyanines are preferably used as a charge generating material.

a titanyl phthalocyanine (A) having a main peak at Bragg angle: 2θ±0.2°=27.2° in CuKα characteristic X-ray diffraction, and (B) having a peak within 50° C. to 270° C. except for peaks caused by vaporization of absorbed water in differential scanning calorimetry,

In addition to characteristic (A), a titanyl phthalocyanine (C) having no peak within 50° C. to 400° C. except for peaks caused by vaporization of absorbed water in differential scanning calorimetry,

In addition to characteristic (A), a titanyl phthalocyanine (D) having no peak within 50° C. to 270° C. and having a peak within 270° C. to 400° C. except for peaks caused by vaporization of absorbed water in differential scanning calorimetry.

Then, a charge generating material having an absorption wavelength within a defined range may be used alone, or a combination of two or more charge generating materials may be used. Further, among these charge generating materials, in particular, electrophotographic photosensitive members having a sensitivity to a wavelength range of 700 nm or more are preferably used for digital optics image forming apparatus (e.g., laser beam printers or fax machine using light sources of laser diodes). As the charge generating material, phthalocyanine based pigment (e.g., metal-free phthalocyanine or titanyl phthalocyanine) are suitably used. Crystal forms of the phthalocyanine based pigment are not particularly limited, and various crystal forms are applied. And then, electrophotographic photosensitive members for analog optics image forming apparatus (e.g., electrostatic copier using white light sources, such as halogen lamps) preferably have a sensitivity to a visible range. Therefore, electrophotographic photosensitive members for such an image forming apparatus is preferably perylene pigment or bisazo pigment.

### (Base Resin)

When a solution containing the charge generating material is applied on the conductive substrate 11 to form the charge generating layer 12, the base resin is used in addition to the charge generating material. As a base resin used for the charge generating layer 12 in the disclosure, the resin similar as the binder resin used for the charge transport layer 13 can be used. The multi-layered photosensitive member 10 (10′) is, however, generally applied with the charge generating layer 12, and then the charge transport layer 13. Therefore, during the application of the charge transport layer, a base resin is selected so that the charge generating layer 13 does not resolve in the application solvent of the charge generating layer 12.

### [Method for Producing Photosensitive Layer]

The multi-layered photosensitive layer of the multi-layered photosensitive member 10 (10′) is formed by laminating the charge generating layer 12, and then laminating the charge transport layer 13 on the conductive substrate 11, or on the undercoat layer 14 formed on the conductive substrate 11.

The charge generating layer 12 of the multi-layered photosensitive member 10 (10′) preferably has a film thickness of 0.1 μm to 5 μm, more preferably 0.1 μm to 3 μm. The charge transport layer 13 preferably has a film thickness of 2 μm to 100 μm, more preferably 5 μm to 50 μm.

The content of the charge generating material in the charge generating layer 12 is not particularly limited, unless it limits the purpose of the disclosure. When the charge generating layer 12 is formed by applying the application liquid, the amount of the charge generating material is preferably from 10 parts by mass to 500 parts by mass, more preferably from 30 parts by mass to 300 parts by mass based on 100 parts by mass of the base resin.

The content of the charge transport material in the charge transport layer 13 is 55 parts by mass or less based on 100 parts by mass of the binder resin, preferably from 5 parts by mass to 55 parts by mass, more preferably from 10 parts by mass to 55 parts by mass. Where, the amount of the charge transport material is total amount of the hole transport material and the electron transport material in the charge transport layer 13. By adjusting the amount of the charge transport material into this range, the multi-layered photosensitive member having improved abrasive resistance is easy to be obtained.

The charge transport layer 13 includes a polycarbonate resin represented by formula (1) as a binder resin. Using the polycarbonate resin represented by formula (1) as a binder resin, the multi-layered photosensitive member 10 (10′) in which the charge transport material is hard to crystallize, and thus has improved electric properties and durability, and high quality is easy to be formed.

The method for forming the charge generating layer 12 includes vacuum deposition of the charge generating material, or application of the application liquid (application liquid including at least a charge generating material, a base resin, and a solvent). Preferred method for forming the charge generating layer 12 is application of the application liquid because expensive deposition apparatus is not required, and operation for forming films is easy. Further, the method for forming the charge transport layer 13 includes application of application liquid including at least a charge transport material, a binder resin, and a solvent.

As solvents for preparation of the application liquid for forming the photosensitive layer, various organic solvents for application liquid for forming the photosensitive layer can be used. Illustrative examples include alcohols, such as methanol, ethanol, isopropanol, or butanol; aliphatic hydrocarbons, such as n-hexane, octane, or cyclohexane; aromatic hydrocarbons, such as benzene, toluene, or xylene; halogenized hydrocarbons, such as dichloromethane, dichloroethane, chloroform, carbon tetrachloride, or chlorobenzene; ethers, such as dimethylether, diethylether, tetrahydrofuran, dioxane, dioxolan, ethylene glycol dimethylether, or diethylene glycol dimethylether; ketones, such as acetone, methylethylketone, methylisobutylketone, or cyclohexanone; esters, such as ethyl acetate or methyl acetate; aprotic polar organic solvents, such as N,N-dimethyl formaldehyde, N,N-dimethyl formamide, or dimethyl sulfoxide. The solvent used for the application liquid for forming the photosensitive layer may be used alone, or two or more application liquid may be used together.

Among the solvents used for the application liquid for forming the photosensitive layer, non-halogenized solvent is preferably used. As a non-halogenized solvent, solvents including a cyclic ether are more preferably used, particularly preferred are used including one or more solvents selected from tetrahydrofuran, and 1,3-dioxolan. Use of non-halogenized solvents as the application liquid for forming the photosensitive layer can decrease environmental load, such as air pollution or land pollution.

Into the application liquid for the charge generating layer or the charge transport layer, any known various additives can be added, as long as the liquid does not adversely affect on the electrophotographic characters. Suitable additives added to the application liquid include, for example, antidegradant (e.g., antioxidant, radical scavenger, singlet quencher, or ultraviolet absorbing agent), softening agent, plasticizer, surface modifier, bulking agent, thickener, dispersion stabilizer, wax, acceptor, or donor. In order to improve dispersibility of the charge transport material or charge generating material, and smoothness of the surface of the photosensitive layer, for example, surfactant or leveling agent may be used as an additive.

The method for applying the application liquid for the charge generating layer or the charge transport layer is not particular limited, and includes methods with a spin coater, an applicator, a spray coater, a bar coater, a dip coater, or a doctor blade.

By the above method, the application liquid is applied to form a film. After that, the formed film is dried, for example, by using a high temperature oven or vacuum oven, to remove solvents in the film. The charge generating layer 12 and the charge transport layer 13 are thereby obtained. The temperature for drying is preferably from 40° C. to 150° C. By drying the film within a temperature of 40° C. to 150° C., solvents are removed quickly, and the charge generating layer 12 and the charge transport layer 13 having uniform thickness can be produced effectively. If the temperature for drying is too high, any component contained in the multi-layered photosensitive layer may be pyrolyzed.

The undercoat layer 14 can be formed as follows. That is, an application liquid is prepared from a resin, inorganic microparticles including zinc oxide or titanium oxide, and a solvent. The application liquid is applied on the conductive substrate, and then dried. The undercoat layer 14 can be thereby formed.

The multi-layered electrophotographic photosensitive member according to the first embodiment of the disclosure as described above has improved abrasive resistance and electric properties, and therefore is suitably used for various image forming apparatuses.

### Second Embodiment

The image forming apparatus according to the second embodiment includes an image bearing member; a charger for charging the surface of the image bearing member; an exposure section for exposing the charged surface of the image bearing member and forming an electrostatic latent image on the surface of the image bearing member; a developing section for developing the electrostatic latent image and forming a toner image; and a transfer section for transferring the toner image from the image bearing member to a transfer target. In this disclosure, the multi-layered electrophotographic photosensitive member according to the first embodiment is used as an image bearing member.

In the image forming apparatus according to the second embodiment, components other than the image bearing member, such as the charger, the exposure section, the developing section, and the transfer section can be suitably selected from any components used for known image forming apparatus.

Preferred image forming apparatus according to the second embodiment is monochrome image forming apparatus, or tandem color image forming apparatus utilizing multiple color toners as described below. Now, tandem color image forming apparatus will be described.

The tandem color image forming apparatus including the multi-layered electrophotographic photosensitive member according to the first embodiment includes a plurality of image bearing members and a plurality of developing sections. The plurality of image bearing members is placed in parallel to a determined direction so as to form different toner images having different colors on each surface. The plurality of developing section is placed opposing to the image bearing members, and has a developing roller. The developing roller bears and conveys a toner on the surface of the roller, the conveyed toner is supplied to the surface of each image bearing member. In the disclosure, the multi-layered electrophotographic photosensitive members according to the first embodiment are each used as each image bearing members.

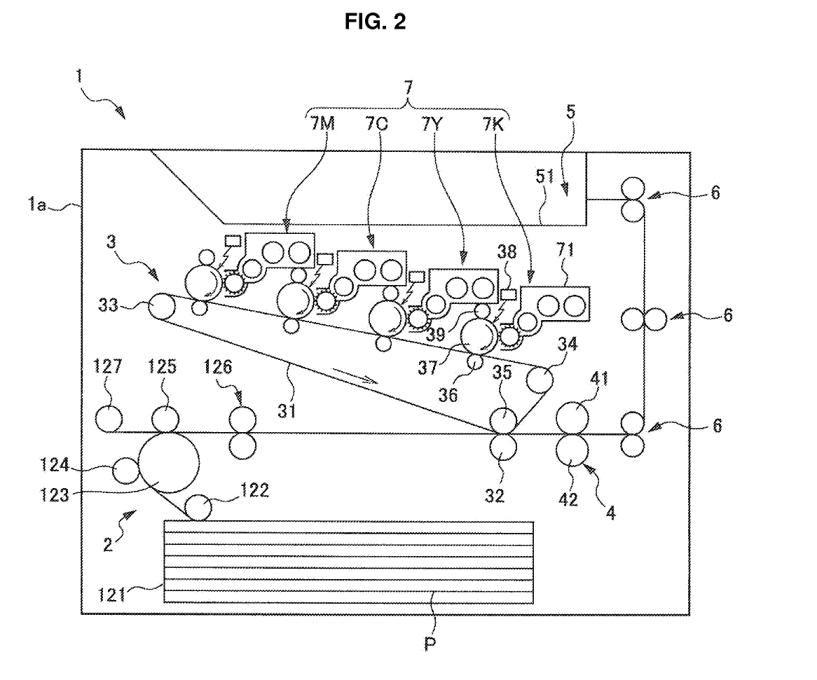

FIG. 2 is a schematic figure showing a configuration of an image forming apparatus having a multi-layered electrophotographic photosensitive member. In the figure, a color printer 1 will be described as an example of the image forming apparatus.

As shown in FIG. 2, the color printer 1 includes a main body 1a having a box shape. Inside the main body 1a, a paper feeder 2, an image forming section 3, and a fixing section 4 are provided. The paper feeder 2 feeds paper P. The image forming section 3 transfers a toner image derived from image data into paper P while moving paper P fed from the paper feeder 2. The fixing section 4 performs a fixing process to paper P in which un-fixed toner image transferred on paper P in the image forming section 3 is fixed on paper P. Further, a paper ejecting section 5 is placed on top surface of the main body 1a. Paper P after the fixing process in the fixing section 4 is ejected from the paper ejecting section 5.

The paper feeder 2 includes a paper feed cassette 121, a pickup roller 122, paper feed rollers 123, 124 and 125, and a registration roller 126. The paper feed cassette 121 is provided removably from the main body 1a. The paper feed cassette 121 accommodates every sizes of paper P. In FIG. 2, the pickup roller 122 is provided at a position in the upper left of the paper feed cassette 121. The pickup roller 122 takes paper P accommodated in the paper feed cassette 121 one by one. The paper feed rollers 123, 124, and 125 sends paper P taken by the pickup roller 122 to a paper conveying path. The registration roller 126 holds temporarily paper P sent to the paper conveying path by paper feed rollers 123, 124, and 125. After that, the registration roller 126 feeds paper P to image forming section 3 with proper timing.

In FIG. 2, the paper feeder 2 further includes a manual feed tray (not shown) mounted at the left side of the main body 1a and a pickup roller 127. The pickup roller 127 takes paper P placed in the manual feed tray. Paper P took by the pickup roller 127 is sent to the paper conveying path by the paper feed rollers 123 and 125, and then the registration roller 126 feeds paper P to image forming section 3 with proper timing.

The image forming section 3 includes an image forming unit 7, an intermediate transfer belt 31, and a secondary transfer roller 32. The toner image derived from image data sent by, for example computer, through the image forming unit 7 is primary transferred to the surface of the intermediate transfer belt 31 (contact surface to the secondary transfer roller 32). The secondary transfer roller 32 is used to secondary transfer of the toner image on the intermediate transfer belt 31 into paper P moved from paper feed cassette 121.

The image forming unit 7 includes a unit for black ink 7K, a unit for yellow ink 7Y, a unit for cyan ink 7C, and a unit for magenta ink 7M serially mounted from the upstream (right side in FIG. 2) to downstream of the printer. Multi-layered electrophotographic photosensitive members 37 (hereinafter, photosensitive members 37) are provided rotatably in the direction of the arrow (in clockwise) as an image bearing member at the center position of each units 7K, 7Y, 7C, and 7M. A charger 39, an exposure section 38, a developing section 71, a cleaner (not shown), and an optional static eliminating section (not shown) are provided around each photosensitive member 37 in this order from the upstream along the direction of rotation. The multi-layered electrophotographic photosensitive member according to the first embodiment is used as the photosensitive member 37.

The charger 39 uniformly charges the peripheral surface of the photosensitive member 37 rotating in the direction of the arrow. The charger 39 is not particularly limited, as long as the peripheral surface of the photosensitive member 37 can be uniformly charged, and may be non-contact type or contact type. Illustrative examples of the charger 39 include a corona charging device, a charging roller, or a charging brush. As the charger 39, contact type charging device, such as charging roller, or charging brush is more preferred, and charging roller is particularly preferred. Use of the charger 39 of contact type can avoid the emission of active gases such as ozone or nitrogen oxides, which is generated by the charger 39. This can prevent the photosensitive layer of the photosensitive member from degradation by active gases. Further, apparatus design that can contribute to a better office environment and the like can be provided.

When the charger 39 includes a charging roller of contact type, the charging roller charges the peripheral surface (surface) of the photosensitive member 37 with it being in contact with the photosensitive member 37. Such a charging roller includes, for example, a roller in contact with photosensitive member 37 which is rotated by following the rotation of the photosensitive member 37. The charging roller also includes, for example, a roller containing a resin on at least surface of the roller. More specifically, the charging roller includes a roller that includes a cored bar rotatably supporting by a shaft; a resin layer formed on the cored bar; a voltage application member applying voltage to the cored bar. The charger including the charging roller can apply voltage to the cored bar in the voltage application member to charge the surface of the photosensitive member 37 that is in contact with the cored bar through the resin layer.

The voltage applied to the charging roller by the voltage application member is not particularly limited. However, the configuration that only direct voltage is applied to the charging roller is more preferred than that alternating voltage or voltage superimposed (voltage in which direct voltage and alternating voltage are superimposed) is applied to the charging roller. In the configuration that only direct voltage is applied to the charging roller, the abrasion amount of the photosensitive layer tends to decrease, and thereby suitable image can be formed. The direct voltage applied to the photosensitive member is preferably from 100 V to 2000 V, more preferably from 1200 V to 1800 V, particularly preferably from 1400 V to 1600 V.

The resin which is a component of the resin layer of the charging roller is not particularly limited, as long as the peripheral surface of the photosensitive member 37 can be charged satisfactory. Illustrative examples of the resin used for the resin layer include silicone resin, urethane resin, or silicone modified resin. The resin layer may contain an inorganic filler.

The exposure section 38 is so called laser scanning unit. The exposure section 38 irradiates the peripheral surface of the photosensitive member 37 uniformly charged by the charger 39 with laser light based on image data input from a personal computer (PC) which is a higher-level apparatus. An electrostatic latent image based on the image data is thereby formed on the photosensitive member 37. The developing section 71 supplies toner to the peripheral surface of the photosensitive member 37 in which the electrostatic latent image was formed to form a toner image based on the image data. Then, the toner image is primary transferred to the intermediate transfer belt 31. The cleaner removes the residual toner from the peripheral surface of the photosensitive member 37 after the toner image is primary transferred to the intermediate transfer belt 31. The static eliminating section eliminates the remaining charge at the peripheral surface of the photosensitive member 37 after the primary transfer. The peripheral surface of the photosensitive member 37 after removal by the cleaner and the static eliminating section moves to the charger 39 for new charging treatment, and then performs the charging treatment. The cleaner and the static eliminating section are not shown in the figures.

The intermediate transfer belt 31 is a rotating body having seamless belt shape. The intermediate transfer belt 31 is wound around a plurality of rollers (a drive roller 33, a driven roller 34, a backup roller 35, and a plurality of primary transfer rollers 36), the surface (contact surface) of the intermediate transfer belt 31 is contacted with the peripheral surface of each photosensitive member 37. Further, the intermediate transfer belt 31 is pushed on each photosensitive member 37 by the primary transfer roller 36 which is placed opposing to each photosensitive member 37. The intermediate transfer belt 31 is rotated by following the rotation of the plurality of rollers with being pressed on the photosensitive member 37. The drive roller 33 drives to rotate by a driving source (e.g., stepping motor), and then forces the intermediate transfer belt 31 to rotate. The driven roller 34, the backup roller 35, and the primary transfer roller 36 are provided rotatably, and rotate by coupled driving according to the rotation of the intermediate transfer belt 31 by the drive roller 33. The rollers 34, 35, and 36 support the intermediate transfer belt 31 in addition to rotation by coupled driving according to the main rotation of the drive roller 33.

The intermediate transfer belt 31 rotates between each photosensitive member 37 and the primary transfer roller 36 in the direction of the arrow (in counterclockwise) by rotation of the drive roller 33. Further, the primary transfer roller 36 applies primary transfer bias (opposite polarity of the charging properties of toner) to the intermediate transfer belt 31. The toner image formed on each photosensitive member 37 is thereby transferred sequentially (primary transferred) to the intermediate transfer belt 31 in repeatedly application. After that, if desired, the remaining charge is eliminated by the static eliminating section (not shown) on the surface of each photosensitive member 37 by using light. After, each photosensitive member 37 further rotates and proceeds for next process.

The secondary transfer roller 32 applies a secondary transfer bias which has opposite polarity to the toner image to paper P. The toner image primary transferred on the intermediate transfer belt 31 is thereby transferred to paper P between the secondary transfer roller 32 and the backup roller 35. Colored transferred image (non-fixing toner image) is transferred on paper P.

The fixing section 4 performs a fixing process to the transferred image on paper P in the image forming section 3. The fixing section 4 includes a heating roller 41 heated by a conductive heating element and a pressure roller 42 which is placed opposing to the heating roller 41 and the peripheral surface of the pressure roller 42 is pushed and contacted with the peripheral surface of the heating roller 41.

The transferred image on paper P by the secondary transfer roller 32 in the image forming section 3 is fixed on paper P by a fixing process with heat when paper P passes between the heating roller 41 and the pressure roller 42. Paper P after the fixing process is then ejected to the paper ejecting section 5. In the color printer 1 of the embodiment, a conveyance roller 6 is placed between the fixing section 4 and the paper ejecting section 5 in an appropriate place.

The paper ejecting section 5 is formed by being recessed from the top of the main body 1a in the color printer 1. The paper ejecting section 5 includes an exit tray 51. The exit tray 51 receives the ejected paper P to the bottom of the recession.

The color printer 1 forms an image on paper P by the image forming operation as described above. The tandem image forming apparatus as described above also includes the electrophotographic photosensitive member according to the first embodiment having improved abrasive resistance and electric properties, as an image bearing member. Therefore, such an image forming apparatus can form high quality images over a long time.

### Example

In Examples and Comparative Examples, the following HTM-1 to HTM-9 were used as a hole transport material (HTM). Further, the following ETM-1 was used as an electron transport material (ETM). Further, Resin-1 to Resin-7, and Resin-9 to Resin-11 including a repeating unit represented by the following formulae were used as a binder resin. Resin-1 had a viscosity average molecular weight of 50,500. Resin-8 had the same repeating unit as Resin-1. Resin-8 was a binder resin having a viscosity average molecular weight of 46,500.

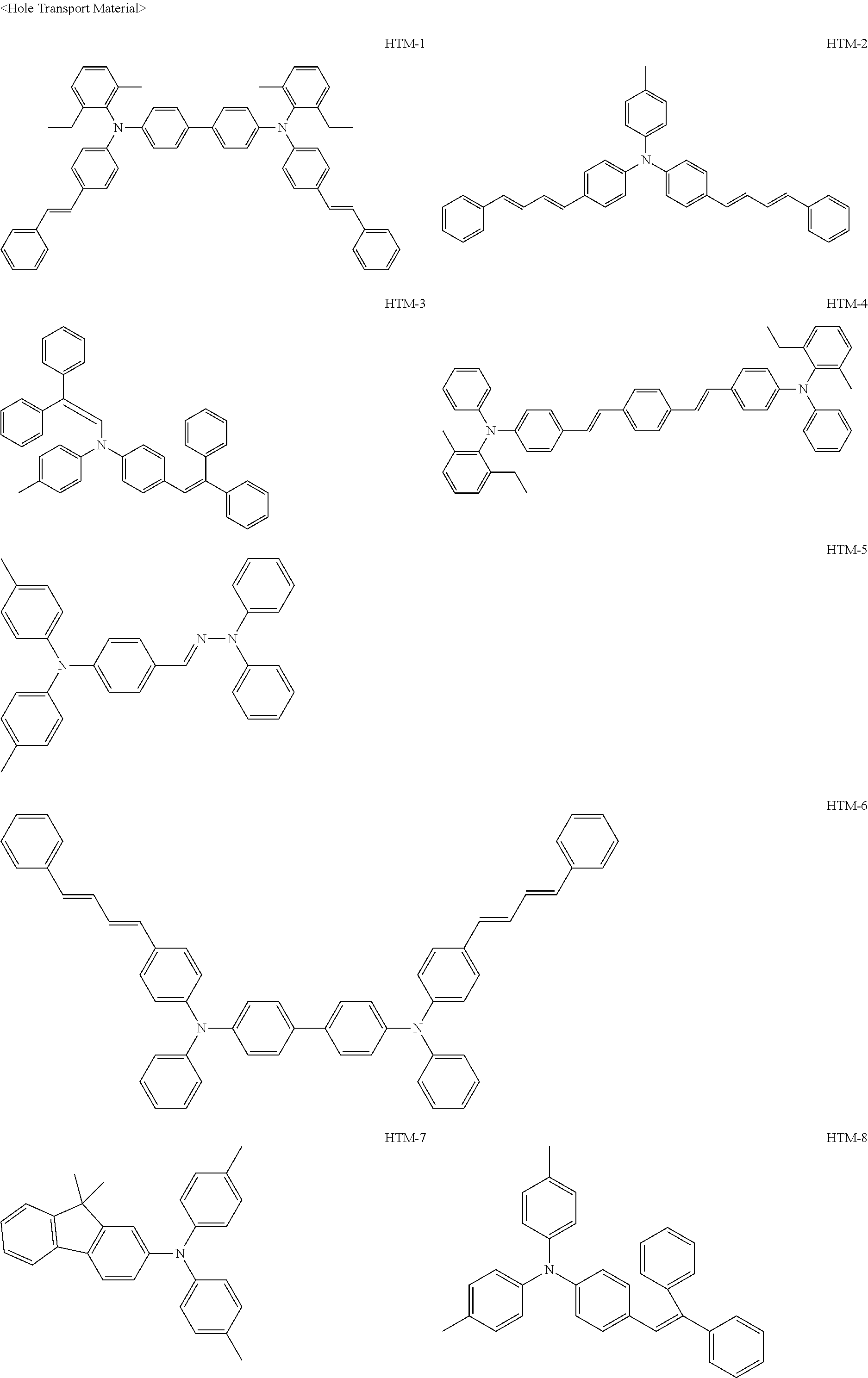

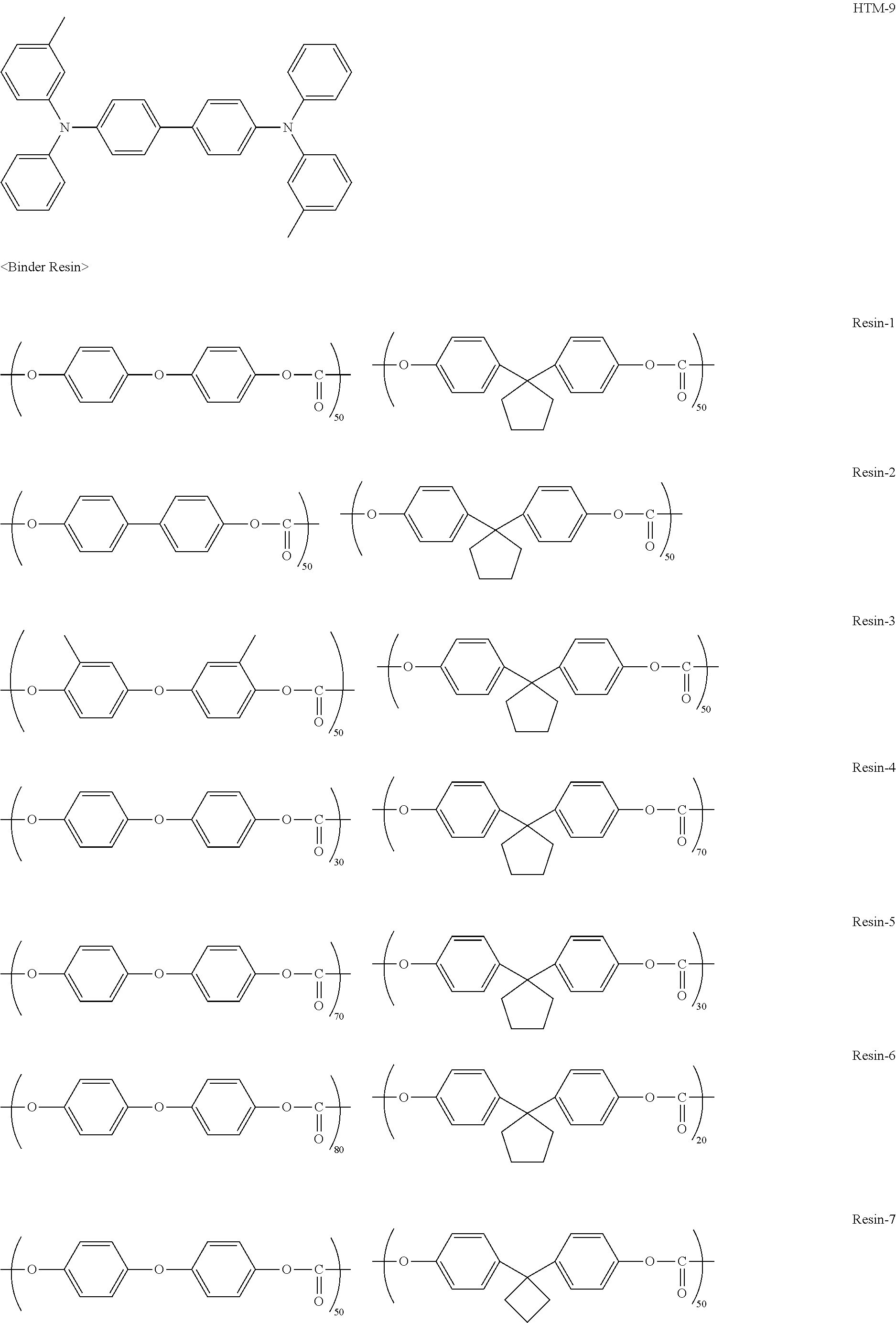

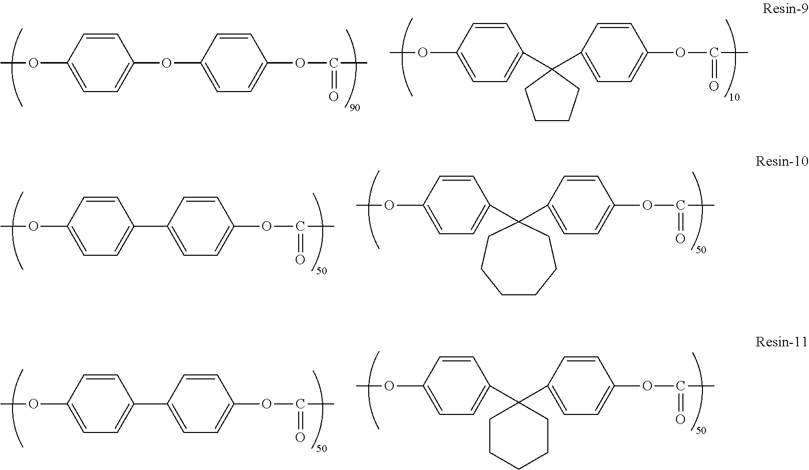

### Examples 1-20 and Comparative Examples 1-3

The photosensitive members of Examples 1-20 and Comparative Examples 1-3 were produced by forming an undercoat layer and then a photosensitive layer on a conductive substrate in this order by the following method.

### [Formation of an Undercoat Layer]

After surface treatment with aluminum and silica, an application liquid for the undercoat layer was prepared by dispersing 2 parts by mass of surface-treated titanium oxide with methyl hydrogen polysiloxane by wet dispersion (manufactured by TAYCA CORPORATION, SMT-A (trial product), number average primary particle size 10 nm) and 1 parts by mass of quarternary copolyamide resin (polyamide 6, polyamide 12, polyamide 66, and polyamide 610 manufactured by Toray Industries, Inc., AMILAN CM8000) in solvent containing 10 parts by mass of methanol, 1 parts by mass of butanol, and 1 parts by mass of toluene with a bead mill for 5 hours.

After filtrating the resulting application liquid for the undercoat layer with a filter having 5 μm openings, the application liquid for the undercoat layer was applied on the conductive substrate which is a drum made by aluminum (diameter 30 mm, total length 246 mm) by dip coating method. After the application of the application liquid, the substrate was treated at 130° C. for 30 minutes to form an undercoat layer having a film thickness of 2 μm on the conductive substrate.

### [Formation of a Photosensitive Layer]

### (Formation of a Charge Generating Layer)

An application liquid for the charge generating layer was prepared by mixing 1.5 parts by mass of Y-form titanyl phthalocyanine (Y—TiOPc, charge generating material), 1 parts by mass of polyvinyl acetal (base resin, manufactured by SEKISUI CHEMICAL CO., LTD., S-LEC BX-5), and a dispersing medium including 40 parts by mass of propylene glycol monomethylether and 40 parts by mass of tetrahydrofuran and dispersing the mixture with a bead mill for 2 hours. After filtrating the resulting application liquid for the charge generating layer with a filter having 3 μm openings, the application liquid for the charge generating layer was applied on the undercoat layer by dip coating method. After the application of the application liquid, the substrate was treated at 50° C. for 5 minutes to form a charge generating layer having a film thickness of 0.3 μm.

### (Formation of a Charge Transport Layer)

An application liquid for the charge transport layer was prepared by resolving 45 parts by mass of a type of the hole transport material as described in Tables 1 and 2, and 100 parts by mass of a type of the binder resin as described in Tables 1 and 2 in a type and amount of the solvent as described in Tables 1 and 2. The resulting application liquid for the charge transport layer was applied on a charge generating layer by similar method as for the charge generating layer. After application, the layer was treated at 120° C. for 40 minutes to form a charge transport layer having a film thickness of 20 μm.

### <<Evaluation of Electric Properties, Appearance, and Abrasive Resistance>>

Multi-layered electrophotographic photosensitive member of Examples and Comparative Examples were evaluated for electric properties, appearance, and abrasive resistance according to the following method. The evaluation results of electric properties, appearance, and abrasive resistance of photosensitive members are shown in Table 3 or 4.

### <Method for Evaluating Electric Properties>

Charging ability and sensitivity were measured by using a drum sensitivity test device (manufactured by Gentec Inc.) at an atmosphere of 20% RH at 10° C. as follows. Electric properties were determined by the measurements of charging ability and sensitivity according to the following standards.

Good: Results of charging ability and sensitivity were “Good)”.

Bad: At least one of results of charging ability and sensitivity was “Bad”.

### (Measurement of Charging Ability)

Surface potential (V₀) of the photosensitive member was measured under inflow current of drum of −10 nA and rotation speed of 31 rpm. Charging ability was determined according to the following standards.

Good: The negative surface potential (V₀) was from −550 V to −750 V.

Bad: The negative surface potential (V₀) was less than −550 V, or more than −750 V.

### (Measurement of Sensitivity)

The surface of the photosensitive member was charged until the surface potential was −600 V. After that, monochromatic light (exposure wavelength: 780 nm) was illuminated on the surface of the photosensitive member at exposure amount of 0.26 μJ/cm². Surface potential (V_{L}) after 50 msec. elapses from the exposure was measured. Sensitivity of the photosensitive member was determined according to the following standards.

Good: The negative surface potential (V_{L}) was −100 V or less.

Bad: The negative surface potential (V_{L}) was more than −100 V.

### <Method for Evaluating Appearance>

Conditions of the surface of the photosensitive member were observed visually. Appearance of the surface of the photosensitive member was determined according to the following standards.

Good: No white cloudiness was observed on the surface of the photosensitive member.

Bad: White cloudiness was observed on the surface of the photosensitive member.

### <Method for Evaluating Abrasive Resistance>

In Examples 1-20 and Comparative Examples 1-3, charge transport layers for measuring their abrasion amount were produced to measure their abrasion amount of the charge transport layer according to the following method. The abrasive resistance was determined according to the following standards.

Good: The abrasion amount was 5 mg or less.

Bad: The abrasion amount was more than 5 mg.

### (Formation of the Charge Transport Layer for Measuring the Abrasion Amount)

Application liquids for the charge transport layer used in Examples 1-20 and Comparative Examples 1-3 were applied on PP (polypropylene) sheet (thickness 0.3 mm) wound on an aluminum pipe having a diameter of 78 mm by dip coating method. After application of the application liquid, applied film was treated at 120° C. for 40 minutes to form a charge transport layer having a film thickness of 30 μm on the PP sheet. After that, the charge transport layer was delaminated from the PP sheet to obtain a charge transport layer for measuring the abrasion amount.

### (Measurement of the Abrasion Amount of the Charge Transport Layer)

The charge transport layers for measuring the abrasion amount were attached to Mounting Card Samples (S-36, manufactured by Taber Industries) to create sheets for measuring the abrasion amount. Taber Abraser (Rotary Abrasion Tester, manufactured by TOYO Precision K.K.), and abrasive wheel (C-10, manufactured by Taber Industries) were used to perform Taber abrasion test under the conditions of a load of 500 g and 1000 rotations at 60 rpm, and. The changed amount of the mass of each sheet for measuring the abrasion amount after the abrasion test from that before the abrasion test was measured as the abrasion amount. The abrasive resistance was determined according to the following standards.

Good: The abrasion amount was 5 mg or less.

Bad: The abrasion amount was more than 5 mg.

TABLE 1

| | hole | binder resin | | | | | | |
|---|---|---|---|---|---|---|---|---|
| | transport | | molecular | | | | solvent | |
| Example | material | type | weight | W | p | n | type | parts |
| 1 | HTM-1 | Resin-1 | 50,500 | - o - | 0.5 | 4 | THF | 350 |
| | | | | | | | toluene | 350 |
| 2 | HTM-2 | Resin-1 | 43,000 | - o - | 0.5 | 4 | THF | 350 |
| | | | | | | | toluene | 350 |
| 3 | HTM-3 | Resin-1 | 42,000 | - o - | 0.5 | 4 | THF | 350 |
| | | | | | | | toluene | 350 |
| 4 | HTM-4 | Resin-1 | 44,000 | - o - | 0.5 | 4 | THF | 350 |
| | | | | | | | toluene | 350 |
| 5 | HTM-5 | Resin-1 | 45,000 | - o - | 0.5 | 4 | THF | 350 |
| | | | | | | | toluene | 350 |
| 6 | HTM-6 | Resin-1 | 44,000 | - o - | 0.5 | 4 | THF | 350 |
| | | | | | | | toluene | 350 |
| 7 | HTM-7 | Resin-1 | 45,000 | - o - | 0.5 | 4 | THF | 350 |
| | | | | | | | toluene | 350 |
| 8 | HTM-8 | Resin-1 | 46,000 | - o - | 0.5 | 4 | THF | 350 |
| | | | | | | | toluene | 350 |
| 9 | HTM-9 | Resin-1 | 50,000 | - o - | 0.5 | 4 | THF | 350 |
| | | | | | | | toluene | 350 |
| 10 | HTM-1 | Resin-2 | 41,000 | single bond | 0.5 | 4 | THF | 350 |
| | | | | | | | toluene | 350 |
| 11 | HTM-1 | Resin-3 | 42,000 | - o - | 0.5 | 4 | THF | 350 |
| | | | | | | | toluene | 350 |
| 12 | HTM-1 | Resin-4 | 42,500 | - o - | 0.3 | 4 | THF | 350 |
| | | | | | | | toluene | 350 |
| 13 | HTM-1 | Resin-5 | 52,000 | - o - | 0.7 | 4 | THF | 350 |
| | | | | | | | toluene | 350 |
| 14 | HTM-1 | Resin-6 | 51,500 | - o - | 0.8 | 4 | THF | 350 |
| | | | | | | | toluene | 350 |
| 15 | HTM-1 | Resin-7 | 45,000 | - o - | 0.5 | 3 | THF | 350 |
| | | | | | | | toluene | 350 |
| 16 | HTM-1 | Resin-1 | 44,000 | - o - | 0.5 | 4 | THF | 700 |
| 17 | HTM-1 | Resin-8 | 44,000 | - o - | 0.5 | 4 | THF | 350 |
| | | | | | | | toluene | 350 |
| 18 | HTM-1 | Resin-1 | 36,000 | - o - | 0.5 | 4 | THF | 350 |
| | | | | | | | toluene | 350 |
| 19 | HTM-1 | Resin-1 | 50,000 | - o - | 0.5 | 4 | chloroform | 700 |
| 20 | HTM-1 | Resin-1 | 50,000 | - o - | 0.5 | 4 | dixolane | 350 |
| | | | | | | | toluene | 350 |

TABLE 2

| | Hole | binder resin | | | | | | |
|---|---|---|---|---|---|---|---|---|
| Comparative | transport | | molecular | | | | solvent | |
| Example | material | type | weight | W | p | n | type | parts |
| 1 | HTM-1 | Resin-9 | 42,500 | - o - | 0.85 | 4 | THF | 350 |
| | | | | | | | toluene | 350 |
| 2 | HTM-1 | Resin-10 | 42,500 | single | 0.50 | 6 | THF | 350 |
| | | | | bond | | | toluene | 350 |
| 3 | HTM-1 | Resin-11 | 42,500 | single | 0.50 | 5 | THF | 350 |
| | | | | bond | | | toluene | 350 |

TABLE 3

| | | | | | evaluation | |
|---|---|---|---|---|---|---|
| | | | | | of abrasive | |
| | evaluation of | | | | resistance | |
| | electric properties | | | | abrasion | |
| | V_{O} | V_{L} | deter- | change of | amount | deter- |
| Example | [V] | [V] | mination | appearance | [mg] | mination |
| 1 | −681 | −82 | Good | Good | 3.3 | Good |
| 2 | −631 | −88 | Good | Good | 3.4 | Good |
| 3 | −691 | −85 | Good | Good | 3.5 | Good |
| 4 | −687 | −82 | Good | Good | 3.5 | Good |
| 5 | −632 | −88 | Good | Good | 3.7 | Good |
| 6 | −691 | −85 | Good | Good | 3.5 | Good |
| 7 | −633 | −84 | Good | Good | 3.4 | Good |
| 8 | −660 | −85 | Good | Good | 3.5 | Good |
| 9 | −670 | −83 | Good | Good | 3.8 | Good |
| 10 | −623 | −91 | Good | Good | 4.0 | Good |
| 11 | −611 | −86 | Good | Good | 4.7 | Good |
| 12 | −654 | −89 | Good | Good | 4.8 | Good |
| 13 | −625 | −87 | Good | Good | 3.1 | Good |
| 14 | −623 | −83 | Good | Good | 3.2 | Good |
| 15 | −605 | −84 | Good | Good | 4.3 | Good |
| 16 | −622 | −83 | Good | Good | 3.8 | Good |
| 17 | −633 | −91 | Good | Good | 3.8 | Good |
| 18 | −633 | −91 | Good | Good | 4.7 | Good |
| 19 | −633 | −91 | Good | Good | 4.6 | Good |
| 20 | −613 | −85 | Good | Good | 4.4 | Good |

TABLE 4

| | | | | | evaluation of | |
|---|---|---|---|---|---|---|
| | evaluation of | | | | abrasive resistance | |
| Com- | electric properties | | | | abrasion | |
| parative | V_{O} | V_{L} | deter- | change of | amount | deter- |
| Example | [V] | [V] | mination | appearance | [mg] | mination |
| 1 | −671 | −120 | Bad | Bad | 4.8 | Good |
| 2 | −683 | −87 | Good | Good | 7.1 | Bad |
| 3 | −674 | −88 | Good | Good | 6.6 | Bad |

Electrophotographic photosensitive members of Examples 1-20 included the charge transport layer containing the polycarbonate resin represented by formula (1) as a binder resin. It is found that these electrophotographic photosensitive members have a value V₀ within an appropriate range and low V_{L} value, so that improved electric properties can be exhibited with less abrasion amount.

In the electrophotographic photosensitive member of Comparative Example 1, the polycarbonate resin represented by formula (1) in which p is too high was used as a binder resin. It is found that the electrophotographic photosensitive member resulted in whitening of the charge transport layer, and decrease of electric properties of the photosensitive member.

In the electrophotographic photosensitive member of Comparative Examples 2 and 3, the polycarbonate resin represented by formula (1) in which n is too high was used as a binder resin. It is found that abrasive resistance of the charge transport layer was significantly decreased.

What is claimed is:

1. A multi-layered electrophotographic photosensitive member comprising:
a multi-layered photosensitive layer, wherein
the multi-layered photosensitive layer includes a charge generating layer that contains a charge generating material and a charge transport layer that contains a charge transport material and a binder resin are layered sequentially, and
the binder resin includes a polycarbonate resin represented by a formula (1): 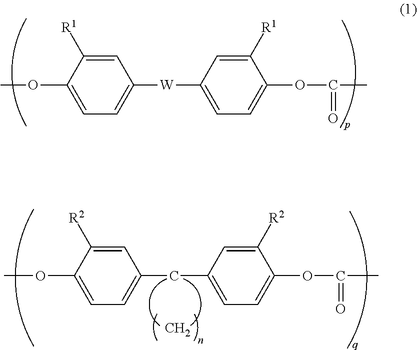
in the formula (1), p+q=1; 0.3≦p≦0.8; W is a single bond, or —O—; R¹ and R² are each independently a hydrogen atom, an alkyl group, or an aryl group; n is 3 or 4.

2. The multi-layered electrophotographic photosensitive member according to claim 1, wherein
the range of p is 0.3≦p≦0.7 in the formula (1),

3. The multi-layered electrophotographic photosensitive member according to claim 1, wherein
the binder resin has a viscosity average molecular weight of 35,000 to 90,000.

4. The multi-layered electrophotographic photosensitive member according to claim 1, wherein
the charge generating material comprises titanyl phthalocyanine, the titanyl phthalocyanine has a main peak at Bragg angle: 2θ±0.2°=27.2° in CuKα characteristic X-ray diffraction, and having a peak within 270° C. to 400° C. except for peaks caused by vaporization of absorbed water in differential scanning calorimeter.

5. The multi-layered electrophotographic photosensitive member according to claim 1, wherein
the charge transport layer is formed by applying an application liquid for the charge transport layer obtained by resolving at least the charge transport material and the binder resin in a solvent containing non-halogenized solvent on the charge generating layer.

6. The multi-layered electrophotographic photosensitive member according to claim 5, wherein
the non-halogenized solvent comprises one or more solvent selected from tetrahydrofuran and 1,3-dioxolan.

7. The multi-layered electrophotographic photosensitive member according to claim 1, wherein
the amount of the polycarbonate resin based on the total amount of the binder resin is 70 percent by mass or more.

8. A method for producing the multi-layered electrophotographic photosensitive member according to claim 1, the method comprising:
forming the charge generating layer that contains a charge generating material on a conductive substrate; and
applying an application liquid for the charge transport layer including at least the charge transport material and the binder resin on the charge generating layer to form the charge transport layer,
wherein the application liquid for the charge transport layer comprises a solvent including non-halogenized solvent.

9. The method for producing the multi-layered electrophotographic photosensitive member according to claim 8, wherein
the non-halogenized solvent comprises one or more solvent selected from tetrahydrofuran and 1,3-dioxolan.

10. An image forming apparatus, comprising:
an image bearing member;
a charger configured to charge a surface of the image bearing member;
an exposure section configured to expose the charged surface of the image bearing member and form an electrostatic latent image on the surface of the image bearing member;
a developing section configured to develop the electrostatic latent image and form a toner image; and
a transfer section configured to transfer the toner image from the image bearing member to a transfer target,
wherein the image bearing member is the electrophotographic photosensitive member according to claim 1.
